(19) United States
(12) Patent Application Publication
(10) Pub. No.: US 2012/0131342 A1
(43) Pub. Date: May 24, 2012

(54) METHOD AND APPARATUS FOR CONTROLLING ACCESS TO DATA BASED ON LAYER

(76) Inventors: Eunah Kim, Seoul (KR); Mi Suk Huh, Suwon-si (KR); Dae Youb Kim, Seoul (KR)

(21) Appl. No.: 13/161,973

(22) Filed: Jun. 16, 2011

(30) Foreign Application Priority Data
Nov. 22, 2010 (KR) 10-2010-0116167

(51) Int. Cl. H04L 9/32

(52) U.S. Cl. 713/168

(57) ABSTRACT

Disclosed is an access control apparatus and method for giving access authority with respect to data. The access control apparatus may encrypt, using a Public Key (PK) of a terminal, a Node Key (NK) of a target layer in which the access authority is to be granted to the terminal, and produce an Access Control List (ACL) of the target layer based on the encrypted NK and ID information of the terminal. Also, the access control apparatus may produce a copy of the ACL based on the produced ACL, and store the produced copy of the ACL in a lower layer.

### CROSS-REFERENCE TO RELATED APPLICATION(S)

This application claims the benefit under 35 U.S.C. §119(a) of Korean Patent Application No. 10-2010-0116167, filed on Nov. 22, 2010, in the Korean Intellectual Property Office, the entire disclosure of which is incorporated herein by reference for all purposes.

### BACKGROUND

1. Field

The following description relates to a data access control apparatus and method, and, more particularly, to an apparatus and method for controlling access of at least one user to data stored in a hierarchical structure.

2. Description of Related Art

In general, the term “access” may denote operations performed by a user or a terminal, such as reading, writing, correcting, storing, and the like, with respect to data stored in another terminal. The word “terminal”, as used in this description, may include mobile terminals such as a smart phone, a digital multimedia broadcasting (DMB) phone, a Moving Picture Experts Group (MPEG) layer 3 (MP3) player, a digital camera, a camcorder, and the like, as well as a personal computer (PC), a notebook, and so on. An access subject may include a terminal, a user of the terminal, another terminal connected over a network, a user of the other terminal, and so on.

An access authority may denote a policy indicating whether an access can be performed or what operations are allowed to be accessed when the access subject accesses data. When another subject, e.g., a user of the terminal, another terminal, a user of the other terminal, and so on, is allowed to access a plurality of data stored in the terminal, the terminal may grant different access authorities to a plurality of respective access subjects to protect the data. In this manner, managing of the access authorities with respect to the data may be referred to as access control.

In particular, when providing directory services in a single system, a conventional access control apparatus may control a terminal to access data or a data set stored in the access control apparatus. In such a case, the data and the data set may be distributed in a storage space structuralized in a hierarchical manner. Accordingly, the access control apparatus may respectively denote terminals capable of accessing each layer to thereby control access of the terminal to the data.

However, the conventional access control apparatus may disseminate an access control policy to a lower layer so that the terminal in which access is allowed to data stored in an upper layer is able to access data of the lower layer, when in actuality the conventional access control apparatus did not intend for the terminal to have such access to the data in the lower layer. Thus, when attempting to correct, in the lower layer, the access control policy inherited from the upper layer, undesired restrictions may occur. Specifically, according to an inheritance rule, the access control policy is unable to be corrected so that the terminal in which access is denoted to be allowed in the upper layer is denied access to the data of the lower layer. Due to the above described inheritance structure, it is difficult for the conventional access control apparatus to set a separate access authority with respect to a specific layer or specific data.

Therefore, there is a need for a technique that may set a separate access authority with respect to specific data in an upper layer and a lower layer.

### SUMMARY

In one general aspect, there is provided an access control apparatus, including a terminal authentication unit to acquire identification (ID) information and a public key (PK) of a terminal, an encryption unit to encrypt a node key (NK) of a target layer to grant access authority to the terminal using the PK of the terminal, an Access Control List (ACL) production unit to produce an ACL of the target layer based on the encrypted NK and the ID information of the terminal, and an ACL copy production unit to produce a copy of the ACL based on link information of the encrypted NK and the ID information of the terminal.

The ACL production unit may produce the ACL of the target layer so as to be different from a previously produced ACL of an upper layer relative to the target layer.

The ACL copy production unit may store the produced copy of the ACL in metadata of data included in the target layer, metadata of a lower layer included in the target layer, metadata of data included in the lower layer, or any combination thereof.

The ACL production unit may update a previously produced ACL of the target layer by adding the encrypted NK and the ID information of the terminal to the previously produced ACL of the target layer, and the ACL copy production unit may update a previously produced copy of the previously produced ACL of the target layer based on the updated ACL of the target layer.

The ACL production unit may reproduce the ACL of the target layer in response to the terminal having the access authority with respect to the target layer, and the ACL copy production unit may reproduce a copy of the ACL of the target layer based on the reproduced ACL of the target layer.

The encryption unit may encrypt data included in the target layer using a data key (DK), and may encrypt the DK using the NK of the target layer.

The access control apparatus may further include a transmission unit to transmit, to the terminal, the encrypted data, an encrypted hierarchical key, and the encrypted DK in response to a data request of the terminal.

The access control apparatus may further include a group production unit to group a plurality of terminals based on user characteristics, and the ACL production unit may produce the ACL so as to grant the access authority to the plurality of terminals included in the group.

The access control apparatus may further include a transmission unit to transmit, to the terminal, a secret key of a group encrypted using a PK of one of the plurality of terminals, an NK encrypted using the PK of the one of the plurality of terminals, a data key (DK) encrypted using a hierarchical key, and data encrypted using the DK in response to the data request of the terminal, and the ACL may include the NK encrypted using the PK of the one of the plurality of terminals and ID information of the group.

The group production unit sub-groups the plurality of terminals included in the group, and the ACL production unit produces the ACL so as to grant the access authority to the terminals included in a sub-group.

In another general aspect, there is provided an access control method, including acquiring identification (ID) information and a public key (PK) of s terminal to authenticate the terminal, encrypting a node key (NK) of a target layer to grant access authority to the terminal using the PK of the terminal, producing an Access Control List (ACL) of the target layer based on the encrypted NK and the ID information of the terminal, and producing a copy of the ACL based on link information of the encrypted NK and ID information of the terminal.

The ACL of the target layer may be produced so as to be different from a previously produced ACL of an upper layer relative to the target layer.

The method may further include storing the produced copy of the ACL in metadata of data included in the target layer, metadata of a lower layer included in the target layer, metadata of data included in the lower layer, or any combination thereof.

The producing of the ACL may update a previously produced ACL of the target layer by adding the encrypted NK and the ID information of the terminal to the previously produced ACL of the target layer, and the producing of the copy of the ACL may update a previously produced copy of the previously produced ACL of the target layer based on the updated ACL of the target layer.

The method may further include reproducing the ACL of the target layer in response to the terminal having the access authority with respect to the target layer; and reproducing a copy of the ACL of the target layer based on the reproduced ACL of the target layer.

The encrypting may include encrypting data included in the target layer using a data key (DK), and encrypting the DK using the NK of the target layer.

The method may further include transmitting, to the terminal, the encrypted data, an encrypted hierarchical key, and the encrypted DK in response to a data request of the terminal.

The method may further include grouping a plurality of terminals base on user characteristics, and the producing of the ACL may produce the ACL so as to grant the access authority to the plurality of terminals included in the group.

The method may further include transmitting, to the terminal, a secret key of a group encrypted using a PK of one of the plurality of terminals, an NK encrypted using the PK of the one of the plurality of terminals, a data key (DK) encrypted using a hierarchical key, and data encrypted using the DK in response to the data request of the terminal, and the ACL may include the NK encrypted using the PK of the one of the plurality of terminals and ID information of the group.

The grouping may include sub-grouping the plurality of terminals included in the group, and the producing of the ACL may produce the ACL so as to grant the access authority to the terminals included in a sub-group.

In another general aspect, there is provided a method of controlling access to a data layer, the method including encrypting a node key (NK) of a target data layer using a public key (PK) of a terminal, and producing an Access Control List (ACL) based on the encrypted NK and ID information of the terminal, wherein the ACL applies only to the target data layer in a plurality of data layers to which access is controlled by a common controller.

The method may further include acquiring the PK and ID information from the terminal in response to the terminal requesting access to the target data layer.

The method may further include producing a copy of the ACL, storing the ACL in the target data layer, and storing the copy of the ACL in one or more of the remaining data layers.

The producing of the ACL may include updating a previously produced ACL.

Other features and aspects may be apparent from the following detailed description, the drawings, and the claims.

### BRIEF DESCRIPTION OF THE DRAWINGS

FIG. 1 illustrates a relationship between an access control apparatus and a plurality of terminals;

FIG. 2 is a flowchart illustrating a process of producing an Access Control List (ACL);

FIG. 3 is a diagram illustrating a hierarchical structure of data stored in a control apparatus;

FIG. 4 is a flowchart illustrating a process of adding a new terminal to an ACL produced in advance;

FIG. 5 is a flowchart illustrating a process of reproducing an ACL by restricting an access authority of a terminal;

FIG. 6 is a flowchart illustrating a process of reproducing an ACL to grant an access authority in a group unit;

FIG. 7 is a block diagram illustrating a configuration of an access control apparatus; and

FIG. 8 is a flowchart illustrating a process of terminal authentication, producing an ACL and its copy, requesting and receiving encrypted data and decoding (decrypting) encrypted data in a terminal to obtain the decoded data.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein may be suggested to those of ordinary skill in the art. The progression of processing operations described is an example; however, the sequence of operations is not limited to that set forth herein and may be changed as is known in the art, with the exception of operations necessarily occurring in a certain order. Also, descriptions of well-known functions and constructions may be omitted for increased clarity and conciseness.

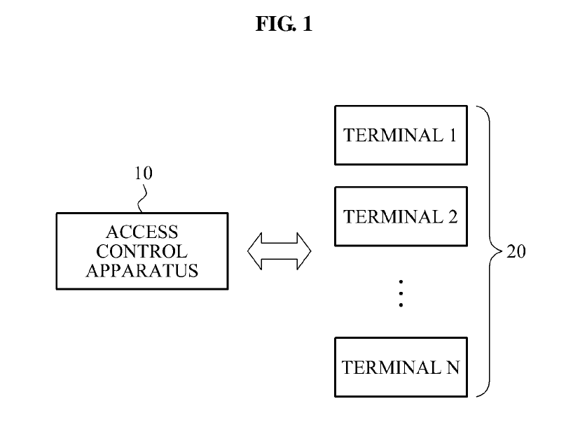

FIG. 1 illustrates a relationship between an access control apparatus 10 and a plurality of terminals 20. Although terminals 1 through N are illustrated in FIG. 1, the described relationship with the access control apparatus 10 may exist with one or any other number of terminals.

Referring to FIG. 1, the access control apparatus 10 may grant, to any number of a plurality of terminals 20, access authority with respect to data. As an example, the access control apparatus 10 may respectively grant, to the plurality of terminals 20 forming a relationship through an authorization operation, authority to access data stored in the access control apparatus 10. Thus, the terminals having the access authority may perform operations such as reading, writing, correcting, storing, and the like with respect to the data stored in the access control apparatus 10.

In this example, the access control apparatus 10 may produce an Access Control List (ACL) to grant the access authority to at least one of the plurality of terminals 20. In such an example, in response to data being requested by any of the plurality of terminals 20, the access control apparatus 10 may verify the access authority of the terminal requesting the data based on the produced ACL. In response to the access authority being verified, the access control apparatus 10 may transmit encrypted data to the terminal requesting the data.

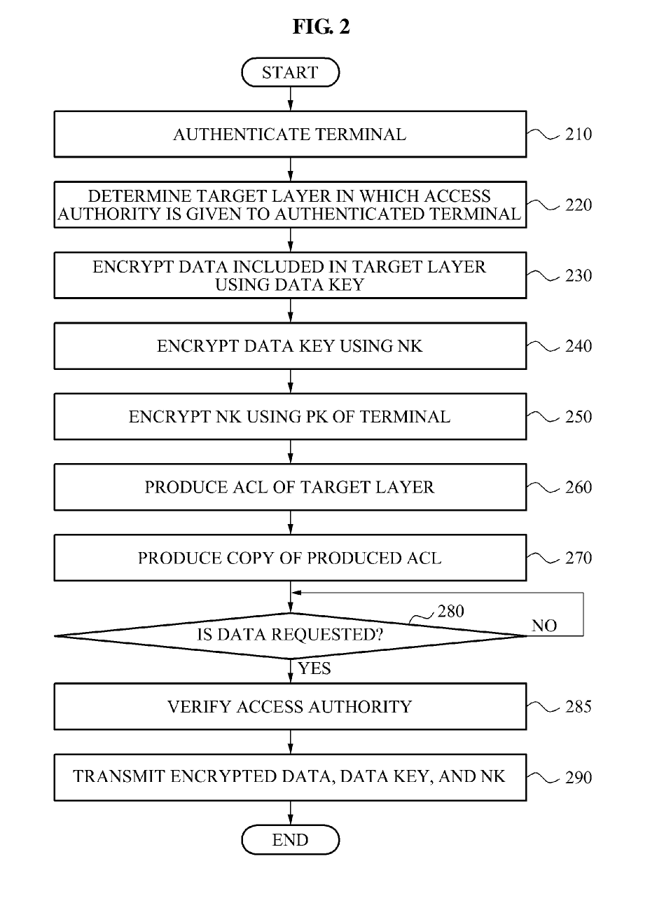

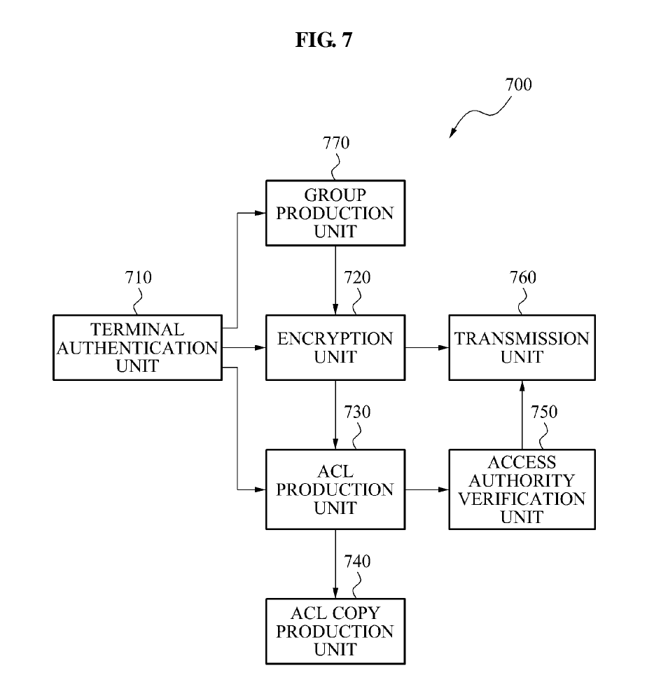

Hereinafter, a process of producing an ACL used to grant access authority with respect to a specific layer or specific data using a node key (NK) will be described in more detail with reference to FIGS. 2 and 7.

FIG. 2 is a flowchart illustrating a process of producing an ACL. FIG. 7, which will be described in more detail later in this description, is a block diagram illustrating a configuration of an access control apparatus 700, and various elements of the access control apparatus are referenced in the discussion of the process illustrated in FIG. 2.

In operation 210, a terminal authentication unit 710 may authenticate a terminal to form a relationship between the access control apparatus 700 and the terminal. In this example, the terminal authentication unit 710 may transmit, to the terminal, a public key (PK) of the access control apparatus 700 in the process of authenticating the terminal, and may receive, from the terminal, the PK of the terminal and identification (ID) information of the terminal. In this example, the ID information of the terminal may include an ID of the terminal.

As an example, in a case of a home network system, the access control apparatus 700 may form a relationship with home devices which represent the aforementioned terminals. Accordingly, the terminal authentication unit 710 may grant access authority with respect to data stored in the access control apparatus 700 by forming a relationship through an authentication operation performed with at least one of the home devices.

As another example, in a case of using a Social Network Service (SNS), the access control apparatus 700 may form a relationship with a family, a school, coworkers, friends, and the like. In this instance, the terminal authentication unit 710 may form the relationship with terminals of the family, the school, the coworkers, friends, and the like through an authentication operation. Next, the authenticated access control apparatus 700 may grant authority to one or more of those terminals so that they are capable of accessing specific data stored in the access control apparatus 700.

As another example, in a case of a distributed network system, the terminal authentication unit 710 may form a relationship with at least one terminal forming a network with the access control apparatus 700 through an authentication operation.

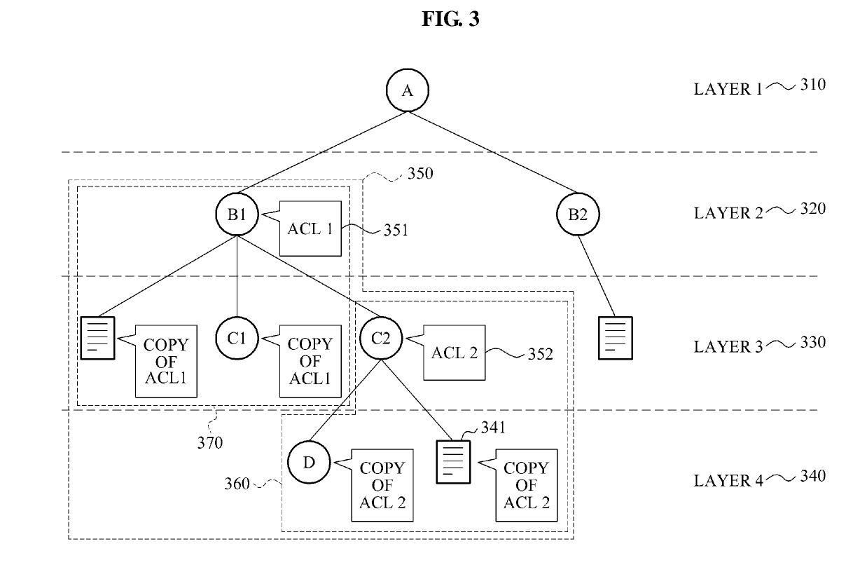

In this instance, the access control apparatus 700 may grant, to the authenticated terminal, access authority with respect to a specific layer or specific data. Also, the access control apparatus 700 may grant access authority with respect to a different layer or different data for each of a plurality of authenticated terminals in the network. In order to grant such authority, in operation 220, an ACL production unit 730 may determine a layer for which the terminal will be authorized to access to grant the access authority to the authenticated terminal. In this example, it may be assumed that data is stored in the access control apparatus 700 in a hierarchical structure. For example, as illustrated in FIG. 3, which is a diagram illustrating a hierarchical structure of data stored in a control apparatus, a layer 1 to a layer 4 (310 to 340) may include a directory, a folder, and the like having a tree structure.

In operation 230, the encryption unit 720 may encrypt data included in the layer which the terminal is authorized to access, which may be referred to as the target layer, using a data key (DK). In this example, the encryption unit 720 may randomly produce the DK using a random function. Alternatively, the encryption unit 720 may produce the DK using a predetermined function, or in any of various other methods of producing such a DK. Thus, the encryption unit 720 may encrypt data included in a target layer to grant access authority to a terminal, using the produced DK.

According to various examples, in response to a plurality of data being included in the target layer, the encryption unit 720 may respectively produce different DKs to correspond to different portions of the data stored in the target layer. The encryption unit 720 may thus respectively encrypt the plurality of data using the produced DK or DKs. As an example, in a case in which data 1, data 2, and data 3 are included in the target layer, the encryption unit 720 may produce a DK 1, a DK 2, and a DK 3, and encrypt the data 1 using the DK 1. Similarly, the encryption unit 720 may encrypt the data 2 using the DK 2, and encrypt the data 3 using the DK 3.

In operation 240, the encryption unit 720 may encrypt the DK using an NK. In this example, as the NK, a symmetric key may be used. However, it is understood that the NK used is not limited to the symmetric key.

As an example, referring to FIG. 3, in a case in which a target layer is (B1), and an ACL or a copy of the ACL has yet to be produced in an upper layer (A) of the target layer (B1), the encryption unit 720 may produce an NK of the target layer (B1) using a random function. Thus, the encryption unit 720 may encrypt the DK using the produced NK of the target layer (B1). In this instance, as another example, when the target layer is (C2), and an ACL or a copy of the ACL exists in an upper layer (B1) of the target layer (C2), the encryption unit 720 may produce an NK of the target layer (C2) using the NK of the target layer (B1). As an example, the encryption unit 720 may produce the NK of the target layer (C2) using the NK of the upper layer (B1) and a unidirectional function such as a hash function and the like. The encryption unit 720 may encrypt the DK using the produced NK of the target layer (C2).

In operation 250, the encryption unit 720 may encrypt the NK of the target layer using a PK of the terminal that is being granted access authority. For example, the PK of the terminal may be acquired in the process of authenticating the terminal in operation 210.

In operation 260, the ACL production unit 730 may produce an ACL of the target layer using the encrypted NK and ID information of the terminal. In this instance, the ACL production unit 730 may produce the ACL of the target layer as shown in Table 1 below.

TABLE 1

ACL of an i-th layer (ACLi)
(IDuser, E(PKuser, NKi))

In Table 1, IDuser may denote ID information of a terminal to which access authority with respect to an i-th layer is granted from among the authenticated terminals, PKuser may denote a PK of the terminal, NKi may denote an NK of the i-th layer, and E(PKuser, NKi) may denote an NK encrypted using the PK of the terminal. Specifically, as shown in Table 1, an ACL of the target layer may include ID information of at least one terminal to which access authority with respect to the target layer is granted, and also include the NK encrypted using the PK of the terminal.

As an example, referring to FIG. 3, in a case in which the target layer is (B1), and access authority with respect to the target layer (B1) is granted to a terminal 1 and a terminal 2, the encryption unit 720 may encrypt (E(PKuser1, NK_{B1})) an NK (NK_{B1}) of the target layer (B1) using a PK (PKuser1) of the terminal 1, and encrypt (E(PKuser2, NK_{B1})) the NK (NK_{B1}) of the target layer (B1) using a PK (PKuser2) of the terminal 2. The ACL production unit 730 may produce an ACL (ACL1: 351) of the target layer (B1) indicating that the access authority with respect to the target layer (B1) is granted to the terminal 1 and the terminal 2. In this instance, the produced ACL (ACL1: 351) of the target layer (B1) may include (IDuser1, E(PKuser1, NK_{B1})) and (IDuser2, E(PKuser2, NK_{B1})).

As another example, referring to FIG. 3, in a case in which the target layer is (C2), and access authority with respect to the target layer (C2) is granted to the terminal 1 and the terminal 3, the encryption unit 720 may encrypt (E(PKuser1, NK_{C2})) an NK (NK_{C2}) of the target layer (C2) using a PK (PKuser1) of the terminal 1, and encrypt (E(PKuser3, NK_{C2})) the NK (NK_{C2}) of the target layer (C2) using a PK (PKuser3) of the terminal 3. The ACL production unit 730 may produce an ACL (ACL2: 352) of the target layer (C2) indicating that the access authority with respect to the target layer (C2) is granted to the terminal 1 and the terminal 3. In this instance, the produced ACL (ACL2: 352) of the target layer (C2) may include (IDuser1, E(PKuser1, NK_{C2})) and (IDuser3, E(PKuser3, NK_{C2})).

In this manner, the ACL production unit 730 may produce an ACL of a lower layer, separately from an ACL of an upper layer, without directly inheriting the ACL of the upper layer in the lower layer. Accordingly, access authority with respect to the lower layer may be granted to specific terminals that are different from terminals to which access authority of the upper layer is granted.

In operation 270, the ACL copy production unit 740 may produce a copy of the ACL of the target layer based on the produced ACL of the target layer. In this instance, the ACL copy production unit 740 may produce the copy of the ACL of the target layer using ID information of the terminal included in the ACL of the target layer and link information of the encrypted NK. The ACL copy production unit 740 may store the produced copy of the ACL in metadata. The link information of the encrypted NK may be a connection path informing a location at which the encrypted NK is stored. The metadata may include metadata of data included in the target layer, metadata of the lower layer included in the target layer, and metadata of data included in the lower layer.

As an example, referring to FIG. 3, the ACL copy production unit 740 may produce a copy of an ACL1 based on a produced ACL1 of the target layer (B1). In this example, the ACL copy production unit 740 may store the produced copy of the ACL1 in data included in the target layer (B1), a lower layer, and metadata of the data included in the lower layer. In more detail, the ACL copy production unit 740 may store the copy of the ACL1 in each of the lower layers (C1 and C2) corresponding to the layer 3 (330), and in metadata of the data. The ACL copy production unit 740 may store the copy of the ACL1 in a lower layer (D) corresponding to a layer 4 (340), and in metadata of that data.

In this example, in response to the target layer being (C2), and an ACL2 of the target layer (C2) being produced in a state in which the ACL1 exists in the upper layer (B1) of the target layer, the ACL copy production unit 740 may produce a copy of the ACL2. The ACL copy production unit 740 may store the produced copy of the ACL2 in data included in the target layer (C2), the lower layer, and metadata of the data included in the lower layer. In more detail, the ACL copy production unit 740 may store the copy of the ACL2 in each of a lower layer (D) corresponding to the layer 4 (340) and metadata of the data. In this example, the ACL copy production unit 740 may replace, with the copy of the ACL2, the copy of the ACL1 stored in each of the lower layer (D) of (C2) and the metadata 341 of that data. Similarly, as the ACL2 of the lower layer (C2) of (B1) is produced in advance, the ACL production unit 730 may replace the copy of the ACL1 stored in the metadata of (C2) with the ACL2.

In operation 280, it may be determined whether data is requested from a terminal If it is determined that data is not requested from a terminal, operation 280 may be repeated, for example, for a predetermined period of time, or until it is determined that data is requested from a terminal, and so on.

In operation 285, in response to data being requested from the terminal in operation 280, an access authority verification unit 750 may verify the access authority of the terminal requesting the data based on the produced ACL and the copy of the ACL.

As an example, the access authority verification unit 750 may retrieve the data requested in a storage medium (not illustrated) of the access control apparatus 700. Such a storage medium may be a component of the access control apparatus 700, or may be separate from and subject to access authority control by the access control apparatus 700. The access authority verification unit 750 may verify the access authority of the terminal requesting the data based on the ACL stored in the metadata of the retrieved data or the copy of the ACL. In this example, in response to ID information corresponding to ID information of the terminal requesting the data exists among the ID information of terminals included in the ACL or the copy of the ACL, the access authority verification unit 750 may verify that the terminal requesting the data has the access authority with respect to the data.

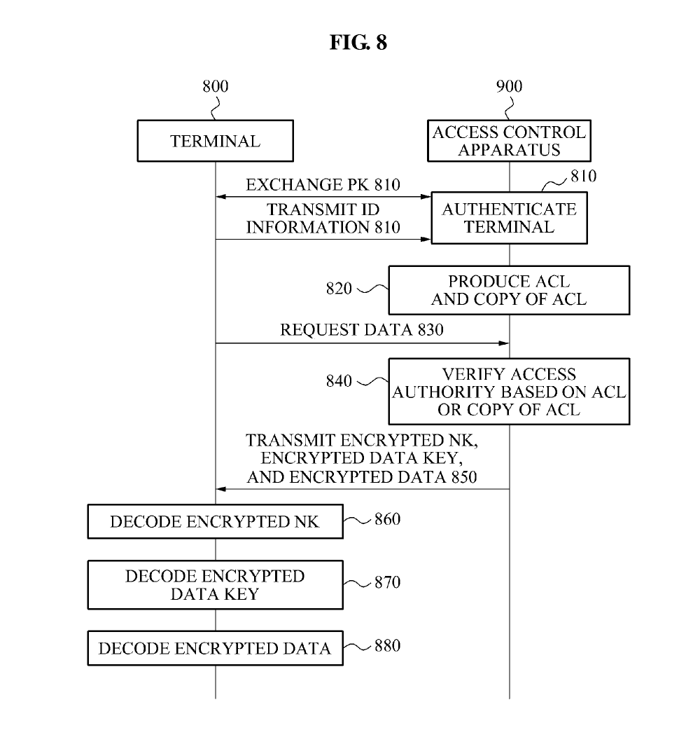

In operation 290, the transmission unit 760 may transmit, to the terminal for which the access authority is verified, encrypted data, an encrypted DK, and an encrypted NK. Accordingly, the terminal may acquire the requested data using the encrypted data, the encrypted DK, and the encrypted NK. A process of acquiring the data requested by the terminal will also be described later with reference to FIG. 8.

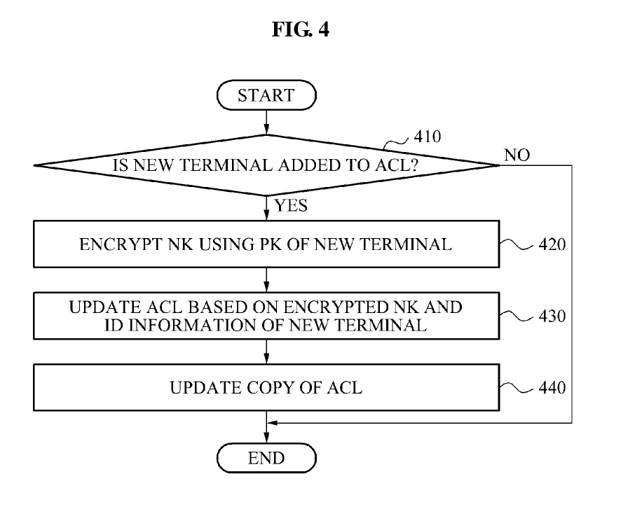

FIG. 4 is a flowchart illustrating a process of adding a new terminal to a previously produced ACL.

In operation 410, it may be determined whether a new terminal is to be added to an ACL previously produced for a target layer.

In operation 420, in response to determining in operation 410 that a new terminal is to be added to the previously produced ACL of the target layer, the encryption unit 720 may encrypt an NK of the target layer using a PK of the new terminal.

In operation 430, the previously produced ACL may be updated based on the encrypted NK and ID information of the added terminal. In more detail, in a case in which the previously produced ACL does exist in the target layer to which the new terminal is to be granted access authority, the ACL production unit 730 may update the previously produced ACL by adding only information of the new terminal to the previously produced ACL. Through the updating of the previously produced ACL, the new terminal may receive the access authority with respect to the target layer.

As an example, as illustrated in FIG. 3, when desiring to grant access authority with respect to the target layer (C2) to a terminal 4, that is, the new terminal, since the ACL2 of the target layer (C2) has been produced in advance, the ACL production unit 730 may update the ACL2 by adding ID information of the terminal 4 and an encrypted NK to the ACL2. In this process, the encryption unit 720 may encrypt the NK of the target layer (C2) using a PK of the terminal 4. Thus, the ACL production unit 730 may add, to the ACL2, the encrypted NK of the target layer (C2) and the ID information of the terminal 4.

In operation 440, the ACL copy production unit 740 may update a copy of the previously produced ACL of the target layer based on the updated ACL.

As an example, the ACL copy production unit 740 may update the copy of the previously produced ACL by adding, to the copy of the previously produced ACL, link information of the encrypted NK of the target layer and the ID information of the new terminal. Thus, the encrypted NK of the target layer may be NK encrypted using the PK of the new terminal.

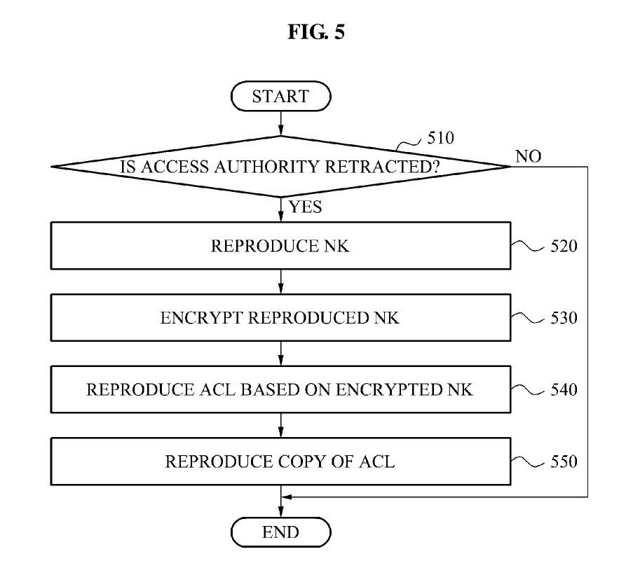

FIG. 5 is a flowchart illustrating a process of reproducing an ACL by restricting the previously granted access authority of a terminal.

In operation 510, it may be determined whether access authority previously granted to a terminal is to be retracted.

In operation 520, in response to an affirmative determination in operation 510, the encryption unit 720 may reproduce an NK of the layer in which the access authority was previously granted to the terminal.

As an example, as illustrated in FIG. 3, in a process of restricting the access authority of the terminal 1 with respect to the target layer (C2), the encryption unit 720 may reproduce an NK of (C2). In this example, since an upper layer (B1) of (C2) exists, and an ACL of an upper layer exists, the encryption unit 720 may reproduce the NK of the layer in which the access authority was previously granted to the terminal, using the NK of the upper layer (B1).

Assuming, in this example, that a copy of the ACL different from the ACL of the upper layer (B1) exists, the encryption unit 720 may reproduce the NK of the layer to which the access authority was previously granted to the terminal, using an NK of a layer corresponding to the copy of the ACL. Also, in an example in which it is assumed that the upper layer of C2 is absent, or the ACL of the upper layer or the copy of the ACL has yet to be produced, the encryption unit 720 may reproduce the NK of C2 using a random function. For example, as the reproduced NK, a symmetric key may be used.

In operation 530, the encryption unit 720 may encrypt the reproduced NK. In this example, the encryption unit 720 may encrypt the reproduced NK using a PK of each of the remaining terminals having access authority, excluding the terminal which is to have the access authority retracted.

As an example, in a case in which access authority with respect to (C2) is granted to the terminal 1, the terminal 3, and the terminal 4, the encryption unit 720 may encrypt the reproduced NK using a PK of each of the terminals 3 and 4, excluding the terminal 1 which is to have the access authority restricted, with respect to C2.

In operation 540, the ACL production unit 730 may reproduce the ACL based on the encrypted NK. In more detail, the ACL production unit 730 may reproduce the ACL of the target layer including remaining terminals having access authority, and excluding a terminal which is to have the access authority restricted, among terminals to which the access authority with respect to the target layer has been previously granted.

As an example, the ACL production unit 730 may reproduce the ACL of (C2) including an NK which was encrypted using a PK of the terminal 3 and ID information of the terminal 3, and an NK which was encrypted using a PK of the terminal 4 and ID information of the terminal 4. The ACL production unit 730 may replace, with the reproduced ACL, the ACL of (C2) which was produced before restricting the access authority of the terminal 1 with respect to (C2).

In operation 550, the ACL copy production unit 740 may reproduce the copy of the ACL based on the reproduced ACL.

As an example, the ACL copy production unit 740 may reproduce the copy of the ACL of (C2) including link information of the NK which was encrypted using the PK of the terminal 3 and the ID information of the terminal 3, and link information of the NK which was encrypted using the PK of the terminal 4 and the ID information of the terminal 4.

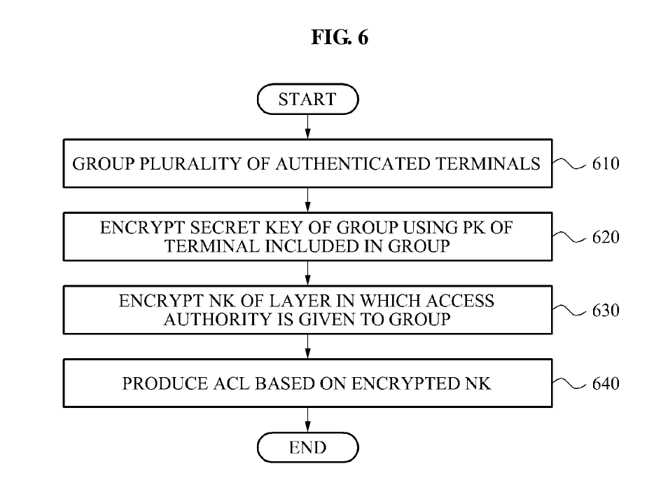

FIG. 6 is a flowchart illustrating a process of reproducing an ACL to grant access authority in a group unit.

In operation 610, a group production unit 770 may group a plurality of authenticated terminals based on user characteristics. As an example, the group production unit 770 may group the authenticated terminals into a family, coworkers, friends, and the like. In this instance, the group production unit 770 may produce group ID information for identifying each group while grouping the authenticated terminals.

In operation 620, the encryption unit 720 may encrypt a secret key of a group using a PK of a terminal included in the group. In this instance, the encryption unit 720 may produce a pair of the secret key of the group and a PK of the group using, for example, the Rivest-Shamir-Adelman (RSA) algorithm, or the like. The encryption unit 720 may encrypt the produced secret key of the group using the PK of the terminal included in the group.

As an example, in a case including a process of grouping the terminals 1 and 3 into a group 1, and the terminals 2 and 4 into a group 2, the encryption unit 720 may produce a pair of a secret key of each of the groups 1 and 2 and a PK from each of the respective groups. The encryption unit 720 may encrypt the secret key of the group 1 using the PK of the terminal 1, or encrypt the secret key of the group 1 using the PK of the terminal 3. Similarly, the encryption unit 720 may encrypt the secret key of the group 2 using the PK of the terminal 2, or encrypt the secret key of the group 2 using the PK of the terminal 4.

Next, in operation 630, the encryption unit 720 may encrypt an NK of a target layer in which the access authority is granted to the group. In this instance, the encryption unit 720 may encrypt the NK of the target layer using a PK of the group.

In operation 640, the ACL production unit 730 may produce an ACL of the target layer based on the encrypted NK of the target layer. In this instance, the ACL production unit 730 may produce the ACL of the target layer including the NK which was encrypted using the PK of the group and ID information of the group.

TABLE 2

ACL of i-th layer with respect to group 1 (ACLi)
(IDuser_group1, E(PKuser_group1, NKi))
Terminal included in group 1
IDuser_subgroup1, E(PKuser_subgroup1, SKuser_group1)
IDuser1, E(PKuser1, SKuser_group1)

In Table 2, IDuser_group1 denotes ID information of a group 1 to which an access authority with respect to an i-th layer is granted, PKuser_group1 denotes a PK of the group 1, NKi denotes an NK of the i-th layer, and E(PKuser_group1, NKi) denotes an NK of an i-th layer encrypted using a PK of the group 1. In addition, IDuser_subgroup1 denotes ID information of a sub-group 1 including at least one terminal included in the group 1, PKuser_subgroup1 denotes a PK of the sub-group 1, SKuser_group1 denotes a secret key of the group 1, E(PKuser_subgroup1, SKuser_group1) denotes a secret key of the group 1 encrypted using the PK of the sub-group 1, IDuser1 denotes ID information of a terminal 1, PKuser1 denotes a PK of the terminal 1, SKuser_group1 denotes a secret key of the group 1, and E(PKuser1, SKuser_group1) denotes a secret key of the group 1 encrypted using the PK of the terminal 1.

As shown in Table 2, the access control apparatus 700 may group a plurality of authenticated terminals, and grant, to the plurality of terminals, access authority with respect to the target layer. The ACL production unit 730 may produce an ACL used for verifying the access authority of the group with respect to the target layer. The produced ACL may include ID information of a sub-group included in the produced ACL.

In addition, in FIG. 6, a process of granting the access authority with respect to the target layer to the group has been described; however, the access control apparatus 700 may grant an access authority with respect to another layer to a sub-group included in the group. As an example, the ACL production unit 730 may produce an ACL of a layer in which an access authority is granted to a sub-group as shown in Table 3 below.

TABLE 3

ACL of (i+1)-th layer with respect to sub-group 1 (ACLi+1)
(IDuser_subgroup1, E(PKuser_subgroup1, NKi+1))
Terminal included in sub-group 1
IDuser2, E(PKuser2, SKuser_subgroup1)
IDuser3, E(PKuser3, SKuser_subgroup1)

In Table 3, IDuser_subgroup1 denotes ID information of a sub-group 1 to which an access authority with respect to an (i+1)-th layer is granted, PKuser_subgroup1 denotes a PK of the sub-group 1, NKi+1 denotes an NK of an (i+1)-th layer, E(PKuser_subgroup1, NKi+1) denotes an NK of an (i+1)-th layer encrypted using the PK of the sub-group 1, IDuser2 denotes ID information of a terminal 2, PKuser2 denotes a PK of the terminal 2, SKuser_subgroup1 denotes a secret key of the sub-group 1, IDuser3 denotes ID information of a terminal 3, PKuser3 denotes a PK of the terminal 3, E(PKuser2, SKuser_subgroup1) denotes a secret key of the sub-group 1 encrypted using the PK of the terminal 2, and E(PKuser3, SKuser_subgroup1) denotes a secret key of a sub-group 1 encrypted using the PK of the terminal 3.

As previously described in relation to FIGS. 2-6, FIG. 7 is a block diagram illustrating a configuration of an access control apparatus.

Referring to the example configuration illustrated in FIG. 7, the access control apparatus 700 includes the terminal authentication unit 710, the encryption unit 720, the ACL production unit 730, the ACL copy production unit 740, the access authority verification unit 750, the transmission unit 760, and the group production unit 770.

The terminal authentication unit 710 may authenticate a terminal with which to form a relationship with the access control apparatus 700. In this instance, the terminal authentication unit 710 may transmit a PK of the access control apparatus 700 to the terminal in a process of authenticating the terminal, and may receive a PK and ID information of the terminal from the terminal.

In the process of granting access authority with respect to a target layer to the authenticated terminal, the encryption unit 720 may encrypt at least one portion of data included in the target layer using a DK. In this instance, the encryption unit 720 may produce the DK using a random function. In a case in which a plurality of data exists, the encryption unit 720 may produce different DKs for different portions of the plurality of data.

The encryption unit 720 may encrypt the at least one DK using an NK of the target layer. The encryption unit 720 may encrypt the NK of the target layer using a PK of the terminal. In this example, the PK of the terminal may be obtained through an authentication operation. In such a case, the encryption unit 720 may produce the NK of the target layer using, for example, the random function, or using an NK of an upper layer of the target layer. A symmetric key may be used as the NK. However, the NK is not limited to such an example.

In addition, in a case in which the authenticated terminals are grouped, the encryption unit 720 may produce a pair of a PK of a group to which an access authority is to be granted and a secret key of the group. The encryption unit 720 may encrypt the NK using the produced PK of the group.

The ACL production unit 730 may produce an ACL based on the encrypted NK and ID information of a terminal to which the access authority is to be granted. In this example, in a case in which an upper layer of the target layer exists, and an ACL of the upper layer or a copy of the ACL exists, the ACL production unit 730 may separately produce an ACL of the target layer, which is different from the ACL of the upper layer.

In more detail, referring to FIG. 3, in a case in which an access authority with respect to (B1) is granted to a terminal 1 and a terminal 2, the ACL production unit 730 may produce an ACL2 indicating that an access authority with respect to (C2) is granted to the terminal 1 and a terminal 3.

In addition, in a case in which access authority with respect to the target layer is granted to a terminal in a state in which the ACL of the target layer has been previously produced, the ACL production unit 730 may update the previously produced ACL of the target layer by adding an encrypted NK and ID information of the terminal to the previously produced ACL of the target layer.

As an example, in a case in which an access authority with respect to (C2) is granted to a terminal 4, the ACL production unit 730 may update a previously produced ACL2 (352) by adding, to the ACL2 (352), an NK encrypted using a PK of the terminal 4 and ID information of the terminal 4.

In addition, in an example in which the access authority with respect to the target layer is to be retracted from a terminal, the ACL production unit 730 may reproduce the ACL of the target layer. In such a case, the encryption unit 720 may reproduce the NK of the target layer. The encryption unit 720 may encrypt the reproduced NK of the target layer using a PK of each of the remaining terminals for which the access authority has been granted with respect to the target layer, excluding the terminal for which the access authority with respect to the target layer is to be retracted. Accordingly, the ACL production unit 730 may reproduce the ACL of the target layer including a pair of the encrypted NK and ID information of the remaining terminals. The ACL production unit 730 may replace an existing ACL of the target layer with the reproduced ACL of the target layer. The ACL copy production unit may produce a copy of the ACL of the target layer based on the produced ACL of the target layer. In such a case, the ACL copy production unit 740 may store the produced copy of the ACL of the target layer in metadata. The metadata may include metadata of data included in the target layer, metadata of a lower layer included in the target layer, and metadata of data included in the lower layer.

As an example, the ACL copy production unit 740 may produce the copy of the ACL including a pair of ID information of the terminal to which access authority with respect to the target layer is granted and link information of an encrypted NK. In such a case, the link information of the encrypted NK may be a connection path indicating a location at which the NK of the target layer is stored, and the encrypted NK of the target layer may be encrypted using a PK of a terminal to which the access authority with respect to the target layer is granted. In this manner, the access control apparatus 700 may reduce a time required for retrieving data requested by the terminal by producing the copy of the ACL.

In addition, the ACL copy production unit 740 may update the copy of the ACL of the target layer based on the updated ACL of the target layer in response to the ACL of the target layer being updated.

As an example, the ACL copy production unit 740 may add, to the previously produced copy of the previously produced ACL, a pair of ID information of the terminal to which the access authority with respect to the target layer is granted and link information encrypted using the PK of the terminal. In this manner, by adding the pair to the copy of the ACL, the copy of the ACL of the target layer may be updated.

In addition, the ACL copy production unit 740 may reproduce the copy of the ACL of the target layer based on the reproduced ACL of the target layer in response to the ACL of the target layer being reproduced. The ACL copy production unit 740 may replace the previously produced copy of the previously produced ACL of the target layer with the reproduced copy of the ACL of the target layer.

In response to data being requested by a terminal, the access authority verification unit 750 may verify the access authority of the terminal with respect to the requested data. In this instance, the access authority verification unit 750 may verify whether the access authority with respect to the data is granted to the terminal based on a copy of the ACL stored in metadata of the requested data or an ACL of the requested data.

In response to the access authority with respect to the data being granted to the terminal, the transmission unit 760 may transmit, to the terminal, encrypted data, an encrypted DK, and an encrypted NK. In this example, the encrypted data may denote that the data requested by the terminal is encrypted using the DK.

In addition, the group production unit 760 may group the plurality of the authenticated terminals into at least one group based on user characteristics. As an example, the group production unit 760 may classify the plurality of terminals into a family, friends, coworkers, and the like to form a group.

The encryption unit 720 may produce a pair of a PK of the produced group and a secret key of the group, using an algorithm producing a pair of the PK and the secret key such as an RSA algorithm, and the like. The encryption unit 720 may encrypt the produced secret key of the group using a PK of a terminal included in the group. The encryption unit 720 may encrypt an NK of the target layer using the PK of the group to which access authority with respect to the target layer is to be granted. The ACL production unit 730 may produce an ACL including a pair of the encrypted NK of the target layer and ID information of the group, as shown in Table 2. In this manner, the access control apparatus 700 may grant access authority in a group unit.

In this example, in response to data being requested by the terminal, and the access authority with respect to the requested data being verified to be granted to the terminal, the transmission unit 760 may transmit, to the terminal, a secret key encrypted using the PK of the terminal, an NK encrypted using the PK of the group, a DK encrypted using the NK, and data encrypted using the DK.

In addition, the group production unit 760 may sub-group at least one of terminals included in the group. The encryption unit 720 may produce a pair of a PK of a produced sub-group and a secret key of the sub-group, and encrypt the produced secret key of the sub-group using a PK of a terminal included in the sub-group.

In this example, in a case in which access authority is to be granted to the subgroup with respect to another layer different from the layer in which the access authority is granted, to a group including the sub-group, the encryption unit 720 may encrypt an NK of the other layer using the PK of the sub-group. As shown in Table 3, the ACL production unit 730 may produce an ACL including a pair of ID information of the sub-group and an NK encrypted using the PK of the sub-group.

In this example, in response to the data being requested by the terminal, and the access authority with respect to the requested data being verified to be granted to the terminal, the transmission unit 760 may transmit, to the terminal, a secret key of the sub-group encrypted using the PK of the terminal, an NK encrypted using the PK of the sub-group, a DK encrypted using the NK, and data encrypted using the DK.

Hereinafter, with reference to FIG. 8, a process of verifying access authority based on an ACL produced in the access control apparatus, and decoding encrypted data based on the verification will be described in more detail.

FIG. 8 is a flowchart illustrating a process of decoding encrypted data in a terminal to obtain the decoded data.

In operation 810, an access control apparatus 900 may authenticate a terminal 800 to form a relationship with the access control apparatus 700. In this example, the access control apparatus 900 and the terminal may exchange a PK with each other through an authentication operation, and the terminal 800 may transmit ID information of the terminal to the access control apparatus through the authentication operation.

In operation 820, as a part of granting access authority with respect to a target layer to the authenticated terminal 800, the access control apparatus 900 may produce an ACL of the target layer. In this example, the access control apparatus 900 may produce a copy of the ACL of the target layer based on the produced ACL. A process of producing the ACL of the target layer and the copy of the ACL has been described in more detail with reference to FIGS. 2 to 7, and thus further description thereof will be omitted.

In operation 830, the terminal 800 may request data from the access control apparatus 900.

In operation 840, the access control apparatus 900 may verify whether access authority with respect to the requested data has been granted to the terminal 800 based on the ACL or the copy of the ACL stored, for example, in metadata of the requested data.

In operation 850, in response to the access authority with respect to the requested data being verified to have been granted to the terminal 800, the access control apparatus 900 may transmit, to the terminal 800, an NK encrypted using the PK of the terminal, a DK encrypted using the NK, and data encrypted using the DK.

In operation 860, the terminal 800 may decode the NK encrypted using the PK of the terminal using a secret key of the terminal.

In operation 870, the terminal 800 may decode the DK encrypted using the decoded NK.

In operation 880, the terminal 800 may decode the encrypted data using the decoded DK.

In addition, in operation 850, in response to the terminal 800 being included in a group or in a sub-group, the access control apparatus 900 may transmit, to the terminal 800, a secret key of the sub-group or the group encrypted using the PK of the terminal, an NK encrypted using the PK of the group or the sub-group, a DK encrypted using the NK, and data encrypted using the DK.

The terminal 800 may decode, using the secret key of the terminal, the secret key of the group or the sub-group encrypted using the PK of the terminal. The terminal 800 may decode the NK using the decoded secret key of the group or the sub-group. Similarly, the terminal 800 may decode the DK encrypted using the decoded NK, and decode the data using the decoded DK.

As described above, a process of producing the ACL to grant the access authority with respect to the target layer has been described; however, the ACL production unit 730 may produce the ACL to grant the access authority with respect to any target data to a specific terminal from among the authenticated terminals.

Also, as described above, verification of the access authority of the terminal requesting the data in the access control apparatus 700 has been described; however, it is possible to verify the access authority of the terminal in the terminal requesting the data. In this instance, the access control apparatus 700 may transmit, to the terminal requesting the data, the ACL stored in the metadata of the data. Accordingly, the terminal itself may verify whether the terminal has access authority with respect to the requested data based on the received ACL.

The method according to the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a non-transitory computer-readable storage medium may be distributed among computer systems connected through a network and non-transitory computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An access control apparatus, comprising:
a terminal authentication unit to acquire identification (ID) information and a public key (PK) of a terminal;
an encryption unit to encrypt a node key (NK) of a target layer to grant access authority to the terminal using the PK of the terminal;
an Access Control List (ACL) production unit to produce an ACL of the target layer based on the encrypted NK and the ID information of the terminal; and
an ACL copy production unit to produce a copy of the ACL based on link information of the encrypted NK and the ID information of the terminal.

2. The access control apparatus of claim 1, wherein the ACL production unit produces the ACL of the target layer so as to be different from a previously produced ACL of an upper layer relative to the target layer.

3. The access control apparatus of claim 1, wherein the ACL copy production unit stores the produced copy of the ACL in metadata of data included in the target layer, metadata of a lower layer included in the target layer, metadata of data included in the lower layer, or any combination thereof.

4. The access control apparatus of claim 1, wherein the ACL production unit updates a previously produced ACL of the target layer by adding the encrypted NK and the ID information of the terminal to the previously produced ACL of the target layer, and the ACL copy production unit updates a previously produced copy of the previously produced ACL of the target layer based on the updated ACL of the target layer.

5. The access control apparatus of claim 1, wherein the ACL production unit reproduces the ACL of the target layer in response to the terminal having the access authority with respect to the target layer, and the ACL copy production unit reproduces a copy of the ACL of the target layer based on the reproduced ACL of the target layer.

6. The access control apparatus of claim 1, wherein the encryption unit encrypts data included in the target layer using a data key (DK), and encrypts the DK using the NK of the target layer.

7. The access control apparatus of claim 6, further comprising:
a transmission unit to transmit, to the terminal, the encrypted data, an encrypted hierarchical key, and the encrypted DK in response to a data request of the terminal.

8. The access control apparatus of claim 1, further comprising:
a group production unit to group a plurality of terminals based on user characteristics,
wherein the ACL production unit produces the ACL so as to grant the access authority to the plurality of terminals included in the group.

9. The access control apparatus of claim 8, further comprising:
a transmission unit to transmit, to the terminal, a secret key of a group encrypted using a PK of one of the plurality of terminals, an NK encrypted using the PK of the one of the plurality of terminals, a data key (DK) encrypted using a hierarchical key, and data encrypted using the DK in response to the data request of the terminal,
wherein the ACL includes the NK encrypted using the PK of the one of the plurality of terminals and ID information of the group.

10. The access control apparatus of claim 8, wherein the group production unit sub-groups the plurality of terminals included in the group, and the ACL production unit produces the ACL so as to grant the access authority to the terminals included in a sub-group.

11. An access control method, comprising:
acquiring identification (ID) information and a public key (PK) of s terminal to authenticate the terminal;
encrypting an node key (NK) of a target layer to grant access authority to the terminal using the PK of the terminal;
producing an Access Control List (ACL) of the target layer based on the encrypted NK and the ID information of the terminal; and
producing a copy of the ACL based on link information of the encrypted NK and ID information of the terminal.

12. The access control method of claim 11, wherein the ACL of the target layer is produced so as to be different from a previously produced ACL of an upper layer relative to the target layer.

13. The access control method of claim 11, further comprising storing the produced copy of the ACL in metadata of data included in the target layer, metadata of a lower layer included in the target layer, metadata of data included in the lower layer, or any combination thereof.

14. The access control method of claim 11, wherein the producing of the ACL updates a previously produced ACL of the target layer by adding the encrypted NK and the ID information of the terminal to the previously produced ACL of the target layer, and the producing of the copy of the ACL updates a previously produced copy of the previously produced ACL of the target layer based on the updated ACL of the target layer.

15. The access control method of claim 11, further comprising:
reproducing the ACL of the target layer in response to the terminal having the access authority with respect to the target layer; and
reproducing a copy of the ACL of the target layer based on the reproduced ACL of the target layer.

16. The access control method of claim 11, wherein the encrypting includes encrypting data included in the target layer using a data key (DK), and encrypting the DK using the NK of the target layer.

17. The access control method of claim 16, further comprising:
transmitting, to the terminal, the encrypted data, an encrypted hierarchical key, and the encrypted DK in response to a data request of the terminal.

18. The access control method of claim 11, further comprising:
grouping a plurality of terminals base on user characteristics,
wherein the producing of the ACL produces the ACL so as to grant the access authority to the plurality of terminals included in the group.

19. The access control method of claim 18, further comprising:
transmitting, to the terminal, a secret key of a group encrypted using a PK of one of the plurality of terminals, an NK encrypted using the PK of the one of the plurality of terminals, a data key (DK) encrypted using a hierarchical key, and data encrypted using the DK in response to the data request of the terminal,
wherein the ACL includes the NK encrypted using the PK of the one of the plurality of terminals and ID information of the group.

20. The access control method of claim 18, wherein the grouping includes sub-grouping the plurality of terminals included in the group, and the producing of the ACL produces the ACL so as to grant the access authority to the terminals included in a sub-group.

21. A method of controlling access to a data layer, the method including:
encrypting a node key (NK) of a target data layer using a public key (PK) of a terminal; and
producing an Access Control List (ACL) based on the encrypted NK and ID information of the terminal;
wherein the ACL applies only to the target data layer in a plurality of data layers to which access is controlled by a common controller.

22. The method of claim 21, further comprising acquiring the PK and ID information from the terminal in response to the terminal requesting access to the target data layer.

23. The method of claim 21, further comprising:
producing a copy of the ACL;
storing the ACL in the target data layer; and
storing the copy of the ACL in one or more of the remaining data layers.

24. The method of claim 21, wherein the producing of the ACL includes updating a previously produced ACL.
